(19) United States
(12) Patent Application Publication
(10) Pub. No.: US 2005/0050052 A1
(43) Pub. Date: Mar. 3, 2005

(54) Centralized management of packaging data with artwork importation module

(75) Inventors: Shannon M. Zimmerman, River Falls, WI (US); Joseph R. Bechtel, River Falls, WI (US); Nicholas J. Nystrom, Racine, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/644,486

(22) Filed: Aug. 20, 2003

(51) Int. Cl. G06F 7/00

(52) U.S. Cl. 707/100

(57) ABSTRACT

A central packaging data (CPD) management system provides an online environment in which customers manage packaging data for their respective products. The CPD management system securely distributes the packaging data to manufacturing sites or other output locations, and allows the customers to control the printed output material applied to their packaging and manufactured products. The CPD management system includes a set of packaging templates having data fields selected from a set of data field types, and an artwork importation module that processes a graphic file to identify elements of a packaging layout. The artwork importer generates metadata that associates each of the elements with a respective one of the data field types of the packaging templates. A record manager presents an interface by which a user forms packaging records based on the metadata. An output manager communicates the packaging record to an output location to control printing of packaging material.

### TECHNICAL FIELD

The invention generally relates to manufacturing technologies and, more particularly, generating labeling and other printed material for packages.

### BACKGROUND

Each year, organizations ranging from sole proprietorships to large corporations produce and ship significant volumes of diverse products. The products, as well as the containers in which they are shipped, typically bear a variety of labels and other printed packaging materials. Each product may use a different container, requiring printed packaging material of different size and shape. In addition, a manufactured product may incorporate many packaging levels from the time the product comes off the manufacturing line to shipment. For some industries, the format and content of the labels at each level may be highly regulated, such as in the health care and pharmaceutical industries.

Large companies may use a number of different software tools, such as graphics design and layout packages, in order to create and print the packaging materials. Coordination of the various packaging materials used throughout an organization, and ensuring compliance with labeling regulations across all of the products, can present a significant challenge for the organization.

In general, a company may employ one or more internal graphic designers or may contract an outside design firm to create the artwork that is to be printed on the packaging material. The designers use graphic design software programs to produce the graphic artwork for a particular packaging material. Examples of common graphic design software programs include QuarkXPress™, Adobe Photoshop™, Adobe Illustrator™, Adobe PageMaker™, Adobe Framemaker™, In-Design™, and the like. The graphic designer typically delivers the artwork in the form of one or more graphic files. In order to modify the artwork, even for minor changes, the company often must request the graphic designer to update the artwork and regenerate the entire graphic. This process can be costly and time consuming.

### SUMMARY

In general, the invention is directed to techniques for centralized management, assembly, and distribution of packaging data. A system is described in which a centralized packaging data (CPD) management system provides host packaging data for a plurality of customers, and provides an online environment with which the customers manage packaging data for their products. The customers interact with the CPD management system to assemble packaging data, and securely distribute the packaging data to respective remote manufacturing sites, print centers or other output locations. In this manner, the system allows the customers to easily control the printed output material applied to their packaging and manufactured products.

The CPD management system includes an artwork importation module that processes a graphic file to parse the graphic file into its constituent elements, i.e., textual, graphical and attribute elements, that form the packaging graphic. The artwork importer generates a data description of the elements, and stores the data description and the separated elements within the CPD management system. The data description of the graphic file may conform to a data description language, such as the eXtensible Markup Language (XML). The data description may be stored within a centralized database, and provides for the elements of the graphic file to be individually retrieved and reused across different packaging materials.

The CPD management system may also include a template manager that allows the customers to associate the elements extracted from a graphic file to fields in one or more packaging templates. By interacting with the template manager, the customer may easily customize and select packaging templates to quickly assemble packaging material based on the extracted elements. Customers can hierarchically organize the templates to reflect the requirements of their specific businesses.

Furthermore, the CPD management system may also include a variety of additional features for the application of business rules to automate the assembly and validation of packaging materials using the elements extracted from the graphic and the defined packaging templates. A rules engine, for example, applies rules to assemble and validate the content of labels or other packaging material, thereby ensuring compliance with the regulations. In addition, the customers can create additional rules to ensure that the packaging materials satisfy their particular requirements. In this manner, the CPD management system provides an intelligent packaging data warehouse with which the customers interact for creation, validation, and distribution of packaging data for labels and other packaging materials associated with products.

In one embodiment, a method comprises processing a graphic file to identify elements of a packaging layout, and generating information that associates the elements with types of data fields of a packaging template. The method further comprises presenting an interface for populating the data fields of the packaging template with the elements in accordance with the information to form a packaging record, and communicating the packaging record to an output location for printing packaging material.

In another embodiment, a packaging data management system comprises a set of packaging templates having data fields selected from a set of data field types, and an artwork importation module that processes a graphic file to identify elements of a packaging layout. The artwork importer generates information that associates each of the elements with a respective one of the data field types of the packaging templates. The packaging data management system further comprises a record manager that presents an interface by which a user selects one of the packaging templates and populates the data fields of the selected packaging template with the elements based on the information to form a packaging record, and an output manager that communicates the packaging record to an output location to control printing of a packaging material.

In another embodiment, an online packaging data management system comprises means for centrally storing packaging templates that define a set of data field types, means for processing a packaging layout to identify elements, means for mapping the elements to the data field types of the packaging templates, and means for generating a packaging record from the elements, the packaging templates, and the mapping.

In another embodiment, a computer-readable medium comprises instructions to cause a processor to process a graphic file to identify elements of a packaging layout, generate information that associates the elements with types of data fields of a packaging template, present an interface for populating the data fields of the packaging template with the elements in accordance with the information to form a packaging record, and communicate the packaging record to an output location for printing packaging material.

The invention may provide one or more advantages. For example, the invention may allow a customer to develop a common process for managing packaging data across business units and manufacturing sites. In this manner, the invention may eliminate redundancies and inefficiencies inherent to a decentralized process.

The customer may, for example, readily develop and manage standardized graphics for the various business units, allowing the company to provide more consistency and accuracy in the appearance of labels entering distribution channels and customer markets. The CPD management system provides a centralized workspace by which users can collaborate to design and create labels and other printed material for new packages, and can reduce cycle times by facilitating the reuse of existing packaging templates and graphics. Moreover, the artwork importer may eliminate the need to redesign an entire graphic for minor changes, and may facilitate the reuse of elements of the packaging graphic. In addition, the CPD management system includes a variety of features for the application of business rules and other constraints to automate the assembly and validation of packaging materials using the packaging templates and elements extracted from artwork received from a graphic designer.

Furthermore, the CPD management system allows a customer to more easily control and manage the packaging data, including the various sizes, layouts, and formats of the output mediums on which the packaging data are printed. In particular, multiple output locations, such as manufacturing facilities and print centers, receive the same packaging data and, therefore, can print identical labels and other print material for packages and manufactured products. The system also provides an efficient mechanism for rapid propagation of changes throughout an organization.

Another advantage of a CPD management system is the ability to support relocation of products from one facility to another. In other words, by centrally managing the packaging data, a company can relocate products from one manufacturing facility to another without needing to transfer labeling information. This process may be difficult when the packaging is managed with conventional desktop graphic design tools that execute on independent workstations.

The CPD management system provides revision control modules for developing and maintaining packaging data. The system, for example, includes mechanisms for checking in and checking out packaging templates and graphics. The system may track modifications of labels and provide revision histories and other modification information.

Another advantage provided by the CPD management system is the ability to support and facilitate “on-demand” print systems by streamlining the delivery of packaging data to such systems when needed. In other words, packaging data can be quickly distributed to print systems when a company decides to manufacture a product, thereby allowing the company to accelerate the satisfaction of any “just-in-time” manufacturing and supply contracts and other business relationships the company may service. In addition, the system supports “run-time” fields that require information at the time of print, such as batch code, lot code, manufacture data, serial number and the like.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example centralized packaging data (CPD) management system that host packaging data for a plurality of customers.

FIG. 2 is a block diagram illustrating the CPD management system of FIG. 1 in further detail.

FIG. 3 is a flowchart that provides a high-level overview of example operation of the central management system.

FIG. 4 is a block diagram proving another high-level overview of the operation of the CPD management system

FIG. 5 illustrates an example packaging graphic to be processed by an artwork importation module of the CPD management system.

FIG. 6 illustrates an example reconciliation interface presented by the artwork importer.

FIG. 7 illustrates an example web-based user interface presented by a template manager.

FIG. 8 illustrates an example web-based user interface presented by a graphics manager.

FIGS. 9-14 illustrate an example web-based user interface presented by a record manager.

FIGS. 15-17 illustrate an example web-based user interface presented by an output manager.

### DETAILED DESCRIPTION

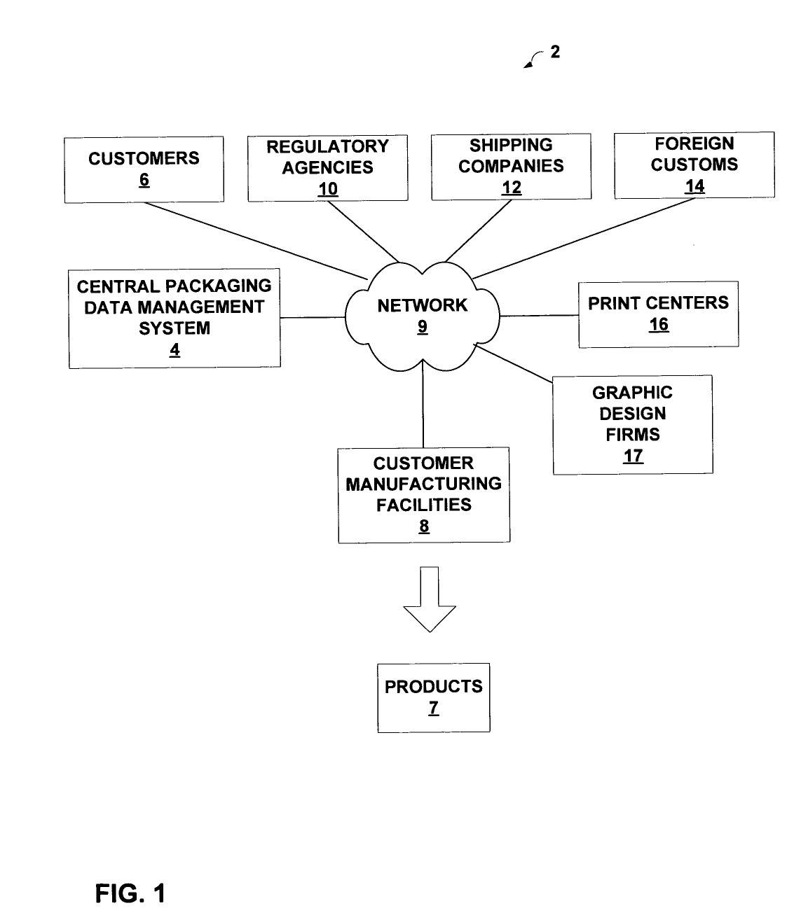

FIG. 1 is a block diagram illustrating a system 2 in which customers 6 communicate with a centralized packaging data (CPD) management system 4 to easily manage packaging data, and assemble the packaging data for application to products 7 by manufacturing facilities 8. More specifically, authorized users of customers 6 interact with CPD management system 4 via network 9 to develop and manage the packaging labels or other printed material for manufactured products. Remote manufacturing facilities 8, print centers 16 or other output locations interact with CPD management system 4 via network 9 to retrieve packaging data for customer approved labels when packaging manufactured products.

Customers 6 may include any organization that manages packaging data for manufactured products generally. In this manner, CPD management system 4 may support customers 6 of all sizes ranging from sole proprietorships to large corporations. For example, customers 6 may include small businesses that outsource packaging to print centers 16, and large businesses, such as Wal-Mart Stores, Incorporated, Best Buy Company, Inc., Intel, Dell Computer Corporation, and the like, that have complex manufacturing facilities 8.

CPD management system 4 includes one or more data servers for hosting the packaging data for customers 6. Examples of such data include packaging templates, graphics, statements of compliance with regulations, translations, lists of ingredients, warnings, and other packaging data. CPD management system 4 securely organizes the data to ensure that the data for a given one of customers 6 is not accessible by any other customers 6.

By interacting with CPD management system 4, customers 6 and can easily generate packaging materials in conformance with requirements from a variety of diverse entities, including regulator agencies 10, shipping companies 12, and foreign customs 14. In other words, CPD management system 4 provides a centralized intelligent system for ensuring that labels or other packaging materials associated with products 7 complies with the specific requirements set forth by regulator agencies 10, shipping companies 12, and foreign customs 14. Examples of regulatory agencies 10 include the Food and Drug Administration (FDA), the Environmental Protection Agency (EPA), and the like. Examples of shipping companies 12 include Federal Express, United Parcel Service, Airborne Express, and the like.

CPD management system 4 includes an artwork importation module (referred to herein as an “artwork importer”) that processes graphic files received from graphic design firms 17 or in-house graphic designers (not shown). In particular, the graphic designers typically use graphic design software programs to produce the graphic artwork that is to be printed on the packaging material via manufacturing facilities 8. Examples of common graphic design software programs include QuarkXPress™, Adobe Photoshop™, Adobe Illustrator™, Adobe PageMaker™, Adobe Framemaker™, In-Design™, and the like. The graphic designer typically delivers the artwork in the form of one or more graphic files.

CPD management system 4 parses the graphic file to extract its constituent elements, e.g., all textual and graphical elements from the graphic file. Example elements include text segments, images, and the like. During this process, CPD management system 4 generates a data description of the elements in conformance with a data description language, such as the eXtensible Markup Language (XML). CPD management system 4 provides a template manager that allows customers 6 to allow customers 4 to associate the constituent elements extracted from the graphic files to specific fields within packaging templates. The CPD management system 4 stores the data description and the individual components, and provides for the elements of the graphic file to be individually retrieved and reused with different packaging templates to form artwork for different packaging materials. As a result, customers 6 may easily customize and select packaging templates and extracted elements for quick assembly of packaging material based on the graphic elements.

In addition, CPD management system 4 may also support a variety of features for application of business rules and other constraints to automate the generation and validation of packaging materials in view of the requirements. For example, as described in detail below, CPD management system 4 provides interfaces for the definition and management of rules, relationships, regulations, and other constraints to control the creation and assembly of packaging material. A host or other service provider associated with CPD management system 4 may provide a base set of rules to customers 6. In addition, customers 6 may interact with the interfaces to easily augment the rule set provided by the service provider of CPD management system 4. A packaging rules engine within CPD management system 4 validates the content and/or structure, i.e. layout, of any assembled labels and other packaging material in view of the requirements. In this manner, CPD management system 4 provides an intelligent packaging data warehouse with which customers 6 interact for creation, validation, and distribution of packaging data for label and other packaging materials associated with products 7.

CPD management system 4 allows customers 6 to define and approve labels including controlling all aspects and features of the printed label including size, layout, graphics, format, warning messages, and the like, as well as the output mediums and print devices on which the labels are printed. In this manner, CPD management system 4 allows customers 6 to better control the layout and appearance of labels being presented to market by manufacturing facilities 8, print centers 16, or other output location. In particular, CPD management system 4 ensures that customers 6 can easily and securely communicate their packaging data to their corresponding manufacturing facilities 8 or other output locations. Consequently, CPD management system 4 ensures that, for a given one of customers 6, different output locations print identical labels and other packaging material for manufactured products 7. In addition, customers 6 may use CPD management system 4 to dynamically control packaging materials used during the manufacturing process.

CPD management system 4 can be used with any labeling device or system and can be used to print labels or other media, or can be used to print directly on packaging material such as folding cartons, boxes, flexible films or the like. Similarly, the packaging data, as defined herein, may be used for a variety of packaging purposes including, for example, to program radio frequency identification (RFID) tags fixed to products at the time of manufacturing. As examples, the RFID tags may be programmed with a lot code, a date of manufacture, a serial number, a UPC code or other packaging data.

Each of customers 6, regulatory agencies 10, shippers 12, and foreign customs 14 may have one or more users that remotely interact with CPD management system 4 via network 9 to develop and manage the packaging labels or other printed material for manufactured products. A user can be any authorized individual, such as a packaging engineer within a business unit, a plant operator within a manufacturing facility 8, an agent within a regulatory agency 10 or a foreign customer 14, a service representative within a shipping company 12, a graphic designer within graphic design firm 17, or a customer service representative within print center 16, and may be geographically distributed. By interacting with CPD management system 4, as described below, users 4 can create, update, and archive packaging data, as well as generate labels for manufactured products.

A graphic designer within a business unit of a one of corporate customers 6 or graphic design firms 17 can create custom graphics displaying, for example, corporate trademarks for use on labels. A packaging engineer may use CPD management system 4 to create packaging templates and define labeling strategies for various “packaging levels” of a product. As referred to herein, packaging levels describe the packaging process that a product undergoes from the time the product comes off the manufacturing line to shipment. Designating a label as packaging level 1 may, for example, indicate that the label is to be placed directly on the product itself. Designating the label as packaging level 3 may indicate that the label is to be placed on a carton holding 10 individual products. Designating the label as packaging level 6 may indicate that the label is to be placed on a case packed with 12 cartons. Finally, designating the template as packaging level 8 may indicate that the label is to be placed on a crate shipped with 200 cases. A plant operator within manufacturing facility 8 may interact with CPD management system 4 to retrieve packaging data and generate appropriate labels for a given product based on the packaging level. In addition, a service representative within print center 16 may carry out high-volume print runs of labels based on packaging data retrieved from CPD management system 4.

Each user typically interacts with a computing device suitable for communication and interaction with CPD management system 4 via network 9. For example, a user may use a workstation, personal computer, laptop computer, or even a personal digital assistant (PDA) such as a Palm™ organizer from Palm Inc. of Santa Clara, Calif. or Windows CE device. The communication device executes communication software, typically a web browser such as Internet Explorer™ from Microsoft Corporation of Redmond, Wash., in order to communicate with CPD management system 4. Network 9 represents any communication link suitable for communicating data, such as a wide-area network, local area network, or a global computer network like the World Wide Web.

By interacting with CPD management system 4, customers 6 can securely develop a centralized label management process for their respective manufacturing facilities 8 and products 7 and, therefore, eliminate redundancies and inefficiencies inherent to a decentralized process. Users of a given company may, for example, develop and manage standardized graphics, allowing the company to provide more consistency and accuracy in the appearance of labeling entering distribution channels and customer markets. As described below, customers 6 can control and manage labels used for packaging, including the various sizes, layouts, formats, as well as the output mediums on which the labels are printed. This allows customers 6 to better control the packaging information being presented to market, i.e., shipped on or with their products 5. In particular, for a given customer, multiple output locations, such as manufacturing facilities 8 and print center 16, and multiple output devices within a location, receive the same packaging data and, therefore, can print identical labels and other print material for packages and manufactured products. Accordingly, by providing access to CPD management system 4, label changes can be propagated universally and instantly throughout an organization.

One advantage of CPD management system 4 is the ability to support relocation of products from one manufacturing facility 8 to another. In other words, because CPD management system 4 centrally manages packaging data, a given one of customers 6, for example, can relocate products from one manufacturing facility to another without needing to transfer labeling information, such as one or more digital files necessary to render a label. This process may be difficult with conventional desktop graphic design and label creation tools that typically execute on standalone workstations.

Another feature of CPD management system 4, as described below, is incorporation of revision control modules for developing and maintaining packaging data. CPD management system 4, for example, includes revision control modules for controlling packaging data through all stages of the process including developing the label, approving the label for use by manufacturing facilities 8 and print center 16, and archiving and time stamping the label for subsequent verification. CPD management system 4 supports, for example, check-in and check-out procedures for controlling access to packaging templates, graphics, and packaging data generally. Furthermore, these features of CPD management system 4 may be useful in tracking changes to labels and providing revision histories and other modification information.

CPD management system 4 supports and facilitates “on-demand” print systems by streamlining the delivery of packaging data to such systems when needed. In other words, packaging data can be quickly distributed to print systems when a company decides to manufacture a product, thereby allowing the company to accelerate the satisfaction of any “just-in-time” manufacturing and supply contracts and other business relationships the company may service.

The service provider of CPD management system 4 may charge customers 6 fees for use of the packaging data management services. The service provider of CPD management system 4 may, for example, charge customers 6 data warehouse fees based on the number of packaging records, templates and graphics, or any combination thereof, stored by each of customers 6. The service provider of CPD management system 4 may also charge fees based on the number of accesses by users within customers 6. In addition, the service provider CPD management system 4 may charge subscription service fees or fees based on the number of labels printed. Alternatively, CPD management system 4 may be offered as a value-add service coupled with other services or packaging materials. For example, services provided by CPD management system 4 may be offered to customers 6 in conjunction with the sale of packaging material, such as packaging tape.

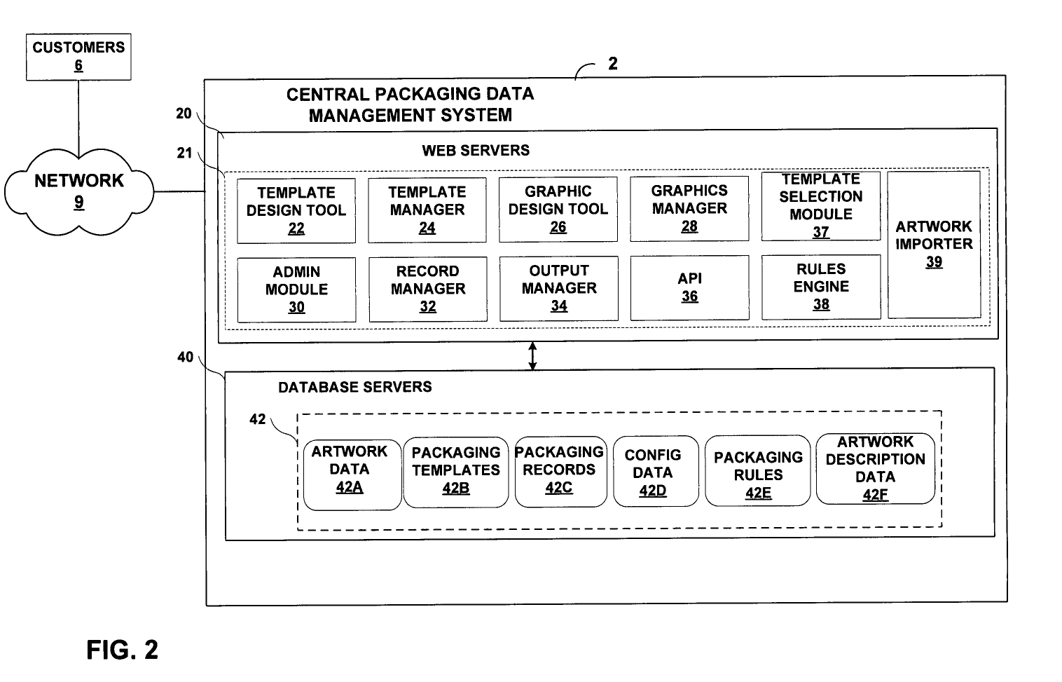

FIG. 2 is a block diagram illustrating an example embodiment of CPD management system 4 with which customers 6 interact to generate packaging materials in conformance with requirements from a variety of diverse entities, such as receiving companies, regulator agencies, shipping companies, global customs, and the like.

Web servers 20 provide an interface by which customers 6 communicate with CPD management system 4 via network 9. In one configuration, web servers 20 execute web server software, such as Internet Information Server™ from Microsoft Corporation, of Redmond, Washington. As such, web servers 20 provide an environment for interacting with customers 6 according to software modules 21, which can include Active Server Pages, web pages written in hypertext markup language (HTML) or dynamic HTML, Active X modules, Lotus scripts, Java scripts, Java Applets, Distributed Component Object Modules (DCOM) and the like.

Although illustrated as “server side” software modules executing within an operating environment provided by web server 20, software modules 21 could readily be implemented as “client-side” software modules executing on computing devices used by customers 6. Software modules 21 could be, for example, implemented as Active X modules executed by a web browser executing on the computing devices. Moreover, although illustrated for exemplary purposes as executing on web servers 20, software modules 21 may alternatively execute on one or more application servers within CPD management system 4.

Software modules 21 may include a number of modules, such as including template design tool 22, template manager 24, graphic design tool 26, graphic manager 28, administration (Admin) module 30, record manager 32, output manager 34, application programming interface (API) 36, template selection module 37, rules engine 38 and artwork importer 39. Software modules 21 interact with database servers 40 to access data 42, which may include artwork data 42A, packaging templates 42B, packaging records 42C, configuration (config) data 42D, packaging rules 42E, and artwork data 42F. Data 42 may be stored in a variety of forms including data storage files, one or more database management systems (DBMS) executing on one or more database servers 40, or combinations thereof. The database management systems may be a relational (RDBMS), hierarchical (HDBMS), multidimensional (MDBMS), object oriented (ODBMS or OODBMS) or object relational (ORDBMS) database management system. Data 42 could, for example, be stored within a single relational database such as SQL Server from Microsoft Corporation.

Artwork data 42A includes text, graphics, or other data extracted by artwork importer 39 from graphics files uploaded by customers 6 for printing on labels or other packaging materials. In this manner, artwork data 42A includes the constituent elements of a graphic file, and each element may comprise textual data or graphical data. Examples of textual elements include warnings, lists of ingredients, tracking numbers, part lists, translations, and the like, or any other text that might be desirable to include on a packaging label. Graphical elements may include corporate graphics, such as trademarks, logos and other imagery, and may be stored as, for example, individual image files stored in any of a number of formats including JPEG, TIFF, GIFF, PDF and the like.

Artwork description data 42F represents information, e.g., in the form of metadata, that describes each packaging graphic uploaded by customers 6. In particular, the metadata describes the composition of each packaging graphic, including the arrangement of the elements stored as artwork data 42A that formulate each packaging graphic. As a result, artwork description data 42F allows CPD management system 4 to reassemble the textual and graphical elements, including retention of the original properties of the elements, to produce packaging graphics for printing on products 7. Artwork description data may conform to a data description language, such as the eXtensible Markup Language (XML), or the like.

Packaging templates 42B store templates for creating labels and other packaging materials associated with products 7, and typically describe a layout, format and a number of user-defined fields. Packaging records 42C store packaging data generated by customers 6 from packaging templates 42B. In particular, a packaging record 42C comprises a record that associates the elements of artwork data 42A, i.e., the text and/or graphical elements extracted from packaging graphics provided by customers 6, with specific fields of packaging templates 42B. In this manner, CPD management system 4 may retrieve and reuse the individual elements of the packaging graphics with different packaging templates to form artwork for different packaging materials. As a result, customers 4 may easily customize and select packaging templates and extracted graphic elements for quick assembly of packaging material based on the elements.

Configuration data 42D stores configuration data including, for example, authorized customers 6, user and corporate preferences, preferred output stock (substrates) for labels, and available printers. In addition, configuration data 42D includes data defining customers 6, manufacturing sites 6, and the various packaging levels used during the manufacturing process.

Template design tool 22 provides online design and layout functionality for creating packaging templates 42B. In other words, template design tool 22 presents a graphical user interface (GUI) by which customers 6 can construct templates. During this process, customers 6 typically define the size and layout for a template, as well as selecting a number of fields for capturing artwork data 42A, possibly at print time. In particular, customers 6 define the templates by selecting fields from a set of field types. If a particular field type is not available, customers 6 may create the desired field type for use within the current and future templates. Although illustrated and described as an online, web-based template design tool, template design tool 22 may comprise conventional label design software, such as CodeSoft™ and LabelView™ from Teklynx™, and may run on independent computing devices.

Upon creating a packaging template, an authorized user of one of customers 6 interacts with template manager 24 to “check-in” the template into CPD management system 4. During this process, template manager 24 parses the data generated by template designer 22, typically a text file with embedded codes defining a number of fields, and stores the parsed data within templates 42B. During the check-in process, the user provides all information necessary for categorizing the template including, for example, a name for the packaging template, other customers 6 that may use the template, markets for which the label may be applicable, a “trustee” for the template, and the corresponding packaging level(s) for which the template applies. After describing the template, the user uploads the file produced by template design tool 22 to CPD management system 4, which stores the file in templates 42B.

Furthermore, customers 6 may interact with template manager 24 to hierarchically organize packaging templates 42B. In other words, template manager 24 allows customers 6 to define and maintain one or more hierarchical relationships for organizing packaging templates 42B. Each of customers 6 may define respective hierarchies for organizing their respective packaging templates, and may customize the hierarchies based on their needs.

A hierarchy may comprise a number of levels, and each level may comprise a number of nodes that correspond to various packaging constraints and other criteria. For example, hierarchies may be defined for criteria such as product lines, industries, countries of origin, countries of destination, selected shipping companies, recipients, and the like. Customers 6 “register” newly created templates by directing template manager 24 to associate each of the templates with a respective node of one of the hierarchies. As described in more detail below, record manager 32 provides an interface with which customers 6 can traverse the hierarchies to easily select appropriate packaging template based on current requirements.

Graphic design tool 26 provides a web-based design tool for creating graphics such as corporate trademarks, logos, and the like. In other words, graphic design tool 26 presents a graphical user interface by which customers 6 can construct packaging graphics for processing and storing as artwork data 42A. Alternatively, uses 18 may use conventional graphic design software, such as QuarkXPress™, Adobe Photoshop™, Adobe Illustrator™, Adobe PageMaker™, Adobe Framemaker™, In-Design™, and the like.

After creating graphics for corporate labels, the user interacts with graphic manager 28 to check-in the packaging graphics into CPD management system 4. During the process, artwork importer 39 parses the graphic files associated with the overall packaging graphic to extract its constituent elements, i.e., all textual, graphical, and attribute elements within the packaging graphic, and stores the extracted elements within artwork data 42A. Examples of textual elements include warnings, lists of ingredients, tracking numbers, part lists, translations, and the like. Graphical elements may include corporate graphics, such as trademarks, logos and other imagery, and may be stored as, for example, individual image files and in any of a number of formats including JPEG, TIFF, GIFF, PDF and the like. Attribute elements may include pixel size, blue line drawings, and the like.

In addition, artwork importer 39 generates artwork data 42F that describes the composition of each packaging graphic uploaded or created by customers 6. During this process, artwork importer 39 may present a reconciliation user interface that allows customers 6 to map each of the extracted elements to one or more types of fields supported by packaging templates 42B. For example, exemplary field types include fields for one or more corporate logos or trademarks, a country of origin field, an address field, a brand name field, “made in” statements, a barcode field, a product number or part number, any number of graphic fields illustrating the product, product descriptions, compliance statements, warning and other safety graphics, an expiration date, a list of ingredients, and the like.

Administration (admin) module 30 presents an interface by which some users, such as system administrators associated with customer 6, are able to configure CPD management system 4. A system administrator may, for example, manage accounts for customers 6 including setting access privileges, and define a number of corporate and user preferences. Examples of corporate preferences include preferred language translations (e.g., source and target languages), signature lines, suggested label stock. Examples of user preferences include authorized printers for each user, as well user access rights to modules 21. Admin module 30 allows the system administrator to define access rights for customers 6 to control the access to the various software modules 21. In this manner, not all users can access all of the software modules 21. For example, a graphic designer may have access rights to graphic design tool 26 and graphics manager 28, while a plant operator may only have access rights for the output manager 34.

In addition, a system administrator can interact with admin module 30 the administrator can define logical categories and hierarchies for characterizing and describing labels used for packaging and manufacturing. The system administrator may define, for example, categories such as markets, business units and a hierarchy of packaging levels, such as levels one through eight. In addition, the system administrator may define a number of label fields supported by CPD management system 4.

Record manager 32 allows the user to define labels or other printed materials associated with manufactured products, based on artwork data 42A, packaging templates 42B, and configuration data 42D. In other words, customers 6 interact with record manager 32 to create new package records 42C for packaging materials based on packaging templates 42B, and populate the fields of the templates with text, graphics or other data.

To create a package record, a user initially directs record manager 32 to select a packaging template 42. To facilitate this process, record manager 32 provides an interface with which customers 6 can traverse the hierarchies to easily select an appropriate packaging template based on current shipping requirements. In particular, record manager 32 incorporates decision-tree logic to filter packaging templates based on a hierarchy selected by the user. As the customer 6 traverses the selected hierarchy, record manager 32 selectively presents the set of packaging templates registered against the currently selected node of the tree. In this manner, record manager 32 allows the user to drill down into storage packaging data to select appropriate templates for assembling and outputting packaging material. For example, record manager 32 may request information from the user, such as a product line, a country of origin, a destination country, an industry, a shipping company, a recipient, and the like. Record manager 32 presents a set of packaging templates 42B that match the supplied criteria.

Upon selecting a template, the user interacts with record manager 32 to populate the fields of the template with text, graphics or other data, and to store the populated template as a new package record 42C. In particular, record manager 23 provides an interface by which the user can search artwork description data 42F to identify graphic or textual elements within artwork data 42A, and associate the elements with fields of the selected template. For example, in association with corporate logo type field, record manager 32 may present a list of the graphical elements of artwork data 42 A that have been associated with the field type. In this manner, the user is able to readily select and reuse constituent elements extracted from packaging graphics uploaded or created by customers 6. In addition, user can set various characteristics and properties for the defined fields for the template. A user may, for example, enable “dynamic scaling” for a text or graphic element associated with a field of the selected template, causing CPD management system 4 to dynamically select a font size for corresponding text or dynamically scale the graphic element, so that the text or graphic element can be fully displayed within the label field.

During the process of assembling a packaging template 42B into a packaging record 42C, record manager 32 engages rules engine 38 to validate the content of the packaging record. Rules engine 38 validates the content of the record in view of packaging rules 42E, which may represent particular constraints, such as regulations from regulatory agencies, requirements for particular shipping companies or recipients, and the like. Packaging rules 42E may also be used to provide informational text, such as comments or suggestions, to customers 6 during the process of assembling packaging records 42C. For example, packaging rules 42E may be created to present an alert consistent with established packaging rules, such as: “Based on your selected destination country of Germany and the selected industry of Health Care, be sure to include a Group Code and a Recycle Number within your packaging record.”

In order to control the application of packaging rules 42E, each of the packaging rules may be associated with one or more fields of packaging templates 42B. As described above, packaging templates 42B are formed from a set of uniquely identified fields. Customers 6 interact with record manager 32 to define packaging rules 42E for validating package records 42C, and to relate the rules to the one or more fields. When invoked by record manager 32 during the process of assembling a new package record 42C, rules engine 38 selectively applies packaging rules 42E to the fields of the new package record. More specifically, rules engine 38 selects and applies packaging rules 42E to the new package record based on the unique identifiers of the fields of the new package record.

As with packaging templates 42B, packaging rules 42E may be organized hierarchically. Records manager 32 provides an interface by which customers 6 define and maintain one or more hierarchical relationships for organizing packaging rules 42E. Each of customers 6 may define respective hierarchies for organizing their respective packaging templates, and may customize the hierarchies based on their needs. As with packaging templates 42B, users may define hierarchies that comprise a number of levels having nodes corresponding to various packaging constraints and other criteria. The users need not necessarily create new hierarchies, but may use common hierarchies to organize both packaging templates 42B and packaging rules 42F. Users “register” newly created packaging rules 42E by directing record manager 24 to associate each of the rules with a respective node of one of the hierarchies. A service provider or other host for CPD management system 4 may provide a set of base rules. Again, however, customers 6 may augment these base rules with customer-specific rules for validating packaging records 42C when assembled. In this manner, system 4 is adaptive to specific customer preferences, and may operate according to different rules for different customers.

Record manager 32 integrates formal control modules and procedures to manage the process of developing and maintaining packaging records 42C. Record manager 32, for example, includes revision control modules for controlling the development of packaging records 42C from creation to approval and archival. Record manager 32 supports, for example, check-in and check-out mechanisms for controlling access to packaging records and tracks modifications to the records to provide revision histories and other modification information. Each of packaging records 42C has a corresponding status, such as draft, pending, approved, archived, obsolete and superceded.

Upon validation, a customer 6 changes a status for a packaging record from “draft” to “approved.” In response, record manager 34 generates an electronic image of the label, such as a PDF (portable document format) output, timestamps the image and archives the image. A version of the image may be stored as a low resolution “thumbnail” to facilitate ready identification by users without the need to retrieve the entire high-resolution image. Record manager 32 associates data from the corresponding packaging record with the archived label image to allow for indexing and quick retrieval. In this manner, CPD management system 4 provides an intelligent packaging data warehouse with which customers 6 interact for creation, validation, and distribution of packaging data for label and other packaging materials associated with products 6.

Output manager 34 controls all aspects of printing. Once a customer 6 has created a template and created a corresponding record for the template by populating the fields of the template with elements selected from artwork data 42A, output manager 34 marks the packaging record available for printing at manufacturing facilities 8 or print centers 16. Only records having an approved status are “published” to manufacturing facilities 8, i.e., are available to customers 6 via the output manager 34. This gives customers 6 the ability to manage data, add new labels, and update labels without concern about the possibility that one of manufacturing sites 6 may prematurely use an unapproved label. As described below, run-time fields can be added to the template during design, which causes output manager 34 to prompt for the information at the time of print. Examples of run-time information include batch code, lot code, manufacture date, serial numbers, and the like. In one embodiment, CPD management system 10 stores the run-time data as labels or other materials are printed for tracking and tracing purposes.

Application programming interface (API) 36 provides the ability to establish direct connections with external computing devices. API 36 may be used to allow such devices to automatically control CPD management system 4, or for automatically retrieving data from such devices. For example, a front-end module, such as a script or command line interface provided by the remote computing device, for example, may communicate with API 36 directly, e.g., bypassing the interfaces presented by other software modules 21. In this manner, the front-end module can automatically interact with CPD management system 4 and thereby control output. As a result, API 36 can be useful when connecting to internal corporate systems to incorporate, for example, product information into a packaging label. In addition, API 36 may be used at manufacturing time to automatically provide run-time information for labels and other printed materials.

API 36 also allows CPD management system 4 to directly access external data sources, such as data sources within customers 6, regulatory agencies 10, shipping companies 12, foreign customs 14, or the like. Record manager 32 may, for example, invoke API for retrieving packaging data directly from a data source maintained by a customer 6.

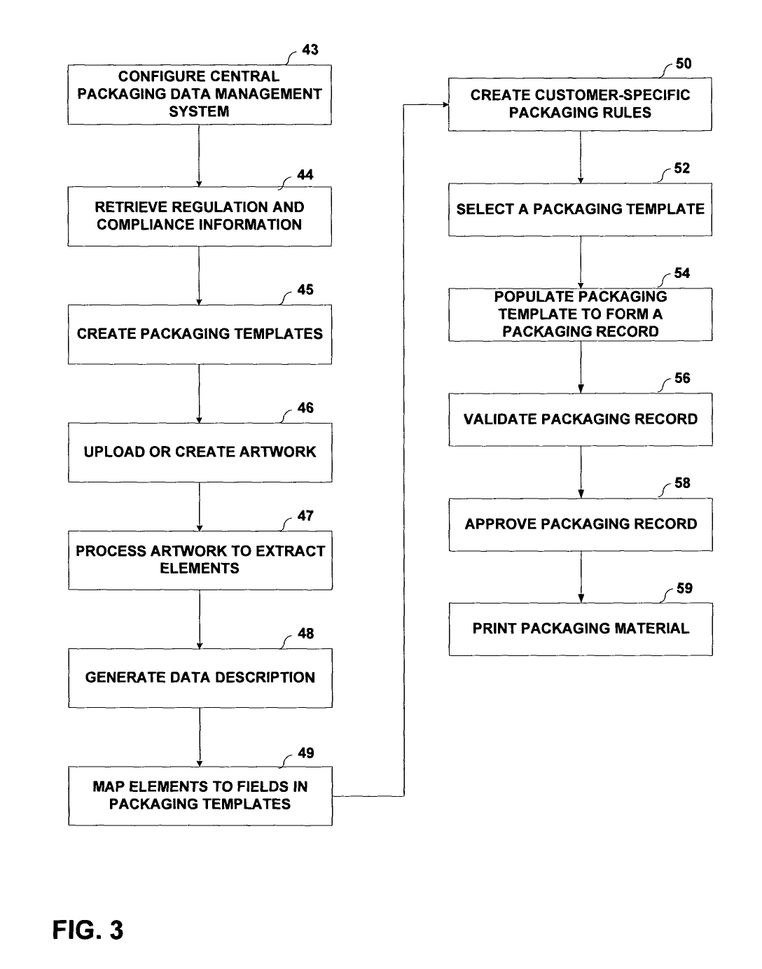

FIG. 3 is a flowchart that provides a high-level overview of example operation of CPD management system 4. Initially, a system administrator of a service provider or other host of CPD management system 4 interacts with admin module 30 to configure the CPD management system (43). For example, the authorized user may add new customers 6, setup user accounts, and define preferences, access rights and the like. In addition, the system administrator may create base sets of packaging templates 42B, packaging rules 42E, as well as hierarchies for organizing the templates and rules. During this process, CPD management system 4 may automatically access and retrieve regulation and compliance information from external data sources, such as regulatory agencies 10, shipping companies 12, foreign customs 14, and customer-specific data sources (44). CPD management system 4 updates packaging rules 42E based on the gathered information, thereby ensuring compliance with the regulations.

Next, an authorized user of a customer 6 may interact with template design tool 22 and template manager 24 to develop customer-specific packaging templates, and register the new templates against the defined hierarchies (45). The authorized user then either uploads packaging artwork or interacts with graphic design tool 26 to create the artwork (46). Artwork for a particular packaging material typically takes the form of a single “layout,” and may comprise one or more graphics files. Artwork importer 39 parses the graphic files associated with the overall packaging graphic to extract its constituent elements, i.e., all textual and graphical elements within the packaging graphic, and stores the extracted elements within artwork data 42A (47). During this process, artwork importer 39 generates artwork data 42F that describes that composition of each packaging graphic uploaded or created by customers 6 (48). Artwork importer 39 may present a reconciliation user interface that allows customers 6 to map each of the extracted elements to one or more types of fields supported by packaging templates 42B (49). In addition, the user may interact with record manager to develop and register customer-specific packaging rules for validating packaging records 42C (50).

Next, the user interacts with record manager 32 to create new packaging records 42C by first selecting one of packaging templates 42B (52). As described above, record manager may invoke decision-tree logic to filter and present a subset of packaging templates 42B based on the hierarchical arrangement of the templates. Upon selecting a template, the user assembles a new packaging record by populating the various fields of the template with text, graphics or other packaging data (54). To populate a given field, record manager 32 may receive input data from the user, retrieve textual or graphical elements from artwork data 42 from stored in database servers 40 based on artwork description data 42F, retrieve data from one or more external databases via API 36, and or the like.

During or after the population process, record manager 32 invokes rules engine 38 to validate the content of each field by application of packaging rules 42E (56). Once validated by record manager 32, and approved by the user, record manger 32 marks the packaging record as “Approved,” thereby allowing access by manufacturing facilities 8 (58). Remote manufacturing facilities 8, print centers 16 or other output locations interact with output manager 34 to securely retrieve packaging records 42C for customers 6, and print approved labels or other materials for manufactured products 7 (59).

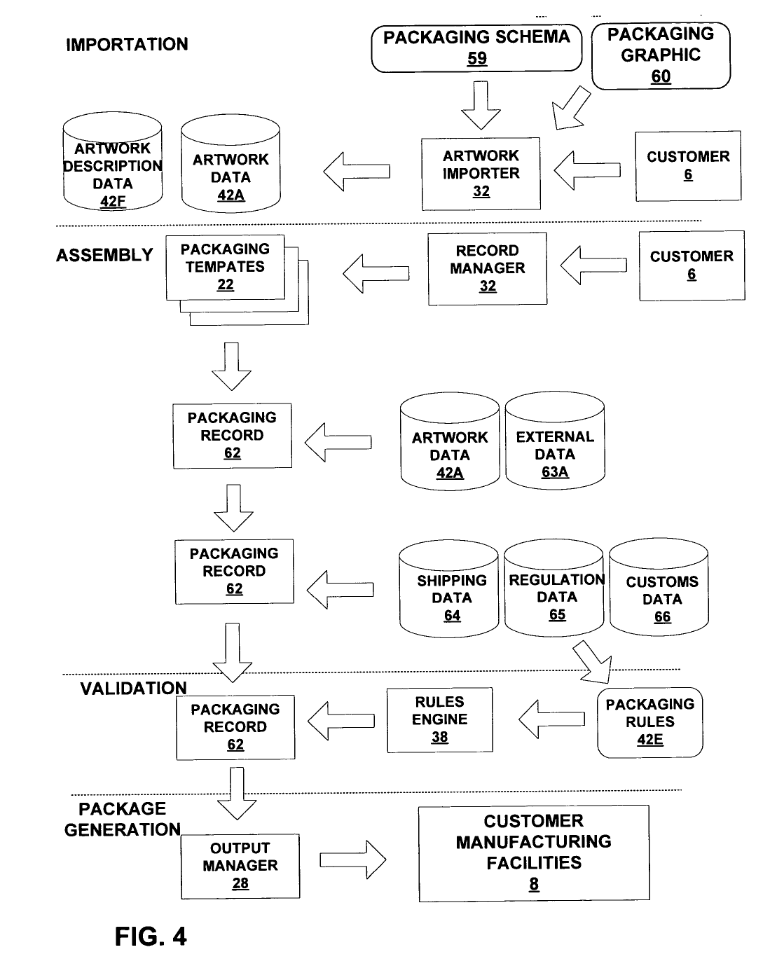

FIG. 4 is a block diagram providing another high-level overview of the operation of CPD management system 4. As illustrated, an authorized user of a customer 6 interacts with artwork importer 32 to import packaging graphics 60 into CDP management system 4. A typical “layout” produced, for example, by graphic design firm 17 for a single packaging instance may comprise a set of one or more graphic files, which may be hierarchically arranged on a computer-readable medium. Moreover, the layout typically includes a plurality of constituent elements having a defined orientation. For example, a layout for a packaging material may include a plurality of textual elements and a plurality of graphical elements. Moreover, the layout defines the orientation of the elements in relation to each other within a two dimensional space that defines the packaging material to be printed.

For each packaging graphic 60 being imported, i.e., each packaging layout, artwork importer 32 analyzes the packaging graphic and identifies the associated graphic files. In addition, artwork importer 32 identifies the graphical elements and the textual elements that makeup the packaging graphic, and determines the orientation of the elements. Based on the identified elements and their orientation, artwork importer 32 applies packaging schema 59 to generate metadata 61 that describes the elements and their orientation. Artwork importer 32 may generate information such as the metadata in a form that complies with a data description language, e.g., the eXtensible Markup Language (XML). Artwork importer 32 stores the metadata as artwork description data 42F, and stores the constituent elements of the imported packaging graphic 60 as artwork data 42A.

The authorized user then interacts with record manager 32 to select a template from packaging templates 42B. As described above, record manager 32 may invoke decision-tree logic to filter and present a subset of packaging templates 42B based on the hierarchical arrangement of the templates.

Upon selecting one of packaging template 42B, the user assembles a new packaging record 62 by populating the various fields of the selected template with text, graphics or other packaging data. Specifically, to populate a given field, record manager 32 may search artwork description data 42F to identify graphic or textual elements within artwork data 42A, that is warehoused by CPD management system 4. In particular, each field within a packaging template may be associated with a graphic or textual element extracted from packaging graphics 60 via artwork importer 32.

In addition, record manager 32 may retrieve data from an external data source 63A, such as a customer database. In particular, each field within a packaging template may be mapped to an external data source for directly retrieving data. To facilitate data transfer, record manager 32 may support data sources that are compliant with the eXtensible Markup Language (XML) or other data description language. As another example, record manager 32 may automatically access and retrieve regulation and compliance information from external data sources, such as shipping data 64, regulation data 65, customer-specific data, and customs data 66. Record manager 32 may incorporate some of this data directly within packaging record 62 as content to be printed on the packaging material. For example, shipping data 64 may include instructions from a selected shipping company to be printed on a label or other packaging material. Furthermore, record manager 32 may update packaging rules 42E based on the gathered information.

Rules engine 38 applies the packaging rules to the contents of the newly created packaging record 62 to validate the content in view of the information gathered from shipping data 64, regulation data 65, customs data 66, or other external data source, as well as customer-specific packaging rules, or rules created by a service provider for CPD management system 4. Once validated, a remote manufacturing facility 8 or other output location interacts with output manager 34 to retrieve packaging record 62 and print a label or other packaging material.

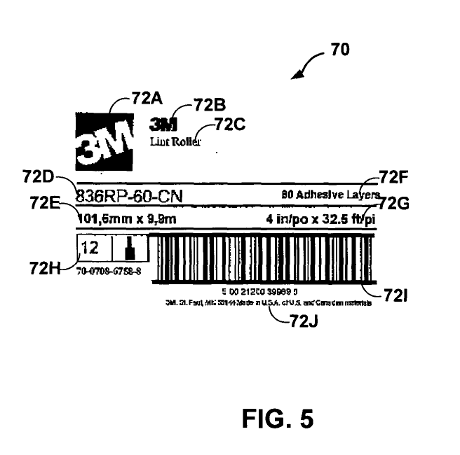

FIG. 5 illustrates an example packaging graphic 70 to be processed by artwork importer 32. As illustrated, the exemplary packaging graphic 70 comprises a plurality of graphical elements and textual elements. In particular, packaging graphic includes graphical trademarks 72A, 72B, a textual product name 72C, a textual product code 72D, textual product information 72E, 72F, 72G, a textual packaging level 72H, a graphical bar code 72I, and textual seller contact information 72J.

Artwork importer 32 processes packaging graphic 70 to extract the graphical and textual elements 72, and stores the elements as artwork data 42A. For example, packaging graphic 70 as produced, for example, by graphic design firm 17 may comprise a set of data files as files:

```
Example_Packaging_Layout.qxd
    graphic_1.eps
    graphic_2.eps
    graphic_3.jpg
    text_seg_1.txt
    text_seg_2.txt
    text_seg_3.txt
    graphic_3.jpg
```

In this example, packaging graphic 70 has been created in a Quark XPress format, and includes a master file “Example_Packaging_Layout.qxd” that defines the overall layout and arrangement of the graphical and textual elements, and links to a set of additional files that store graphical and textual elements.

Artwork importer 32 processes packaging graphic 70 to identify the data files and the graphical and textual elements 72 defined by the layout and stored within the data files. Artwork importer 32 processes the layout file to search for and identify tagged data that describes the elements stored by the data files as well as the attributes and orientation of the elements within the overall layout. Once the elements are identified, artwork importer 32 presents reconciliation user interface that allows a user to map each of the elements to one or more types of fields supported by packaging templates 42B, generates artwork description data 42F based on the mapping, and stores the elements as artwork data 42A in a manner that allows each element to be individually retrieved and reused on packaging material.

Although illustrated for exemplary purposes with reference to Quark XPress format, packaging graphic 70 may take the form of any of a number of different formats. To support the different formats, artwork importer 39 may include a set of respective modules, e.g., “plug-ins,” each module having specialized logic to process a different layout format.

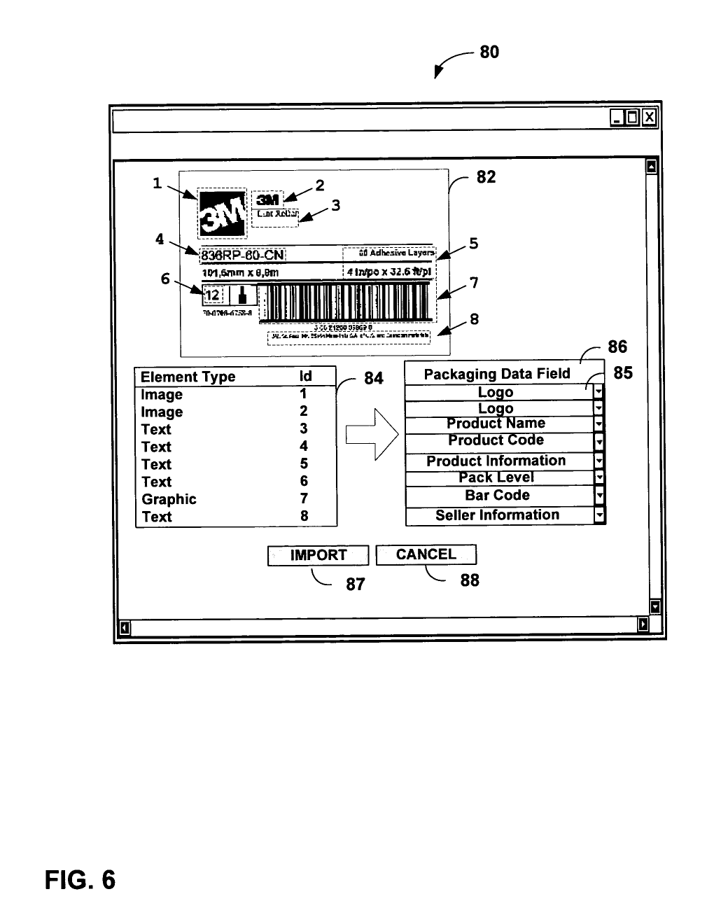

FIG. 6 illustrates an example reconciliation interface 80 presented to the user by artwork importer 32. In the illustrated embodiment, reconciliation interface 80 includes a display area 82 that illustrates the graphic being imported, an element description area 84, and a data type assignment area 86. Element description area 84 presents a list of graphical and textual elements identified by artwork importer 39 within the graphic. For each element, artwork importer 39 generates element description area 84 to list an associated element type, e.g., graphical or textual, and an element identifier (“ID”) assigned by the artwork importer. To aid the importation, artwork importer 39 may generate display area 82 to graphically highlight each element with a respective identifier and an area indicator (illustrated identifiers 1-8 and dashed lines in FIG. 6).

The user interacts with data type assignment area 86 to map each identified element to a type of data field supported by packaging templates 42B. Specifically, data type assignment area 86 provides a respective input area, e.g., drop-down menu 85, for each element identified within the packaging graphic. The user interacts with the input areas to assign a field type to each of the elements. Artwork importer 39 generates the available field types based on the packaging templates 42B and, in particular, a data model defined by the fields of the templates.

Upon assigning a field type to each of the elements, the user may direct artwork importer to import the packaging graphic by selecting the IMPORT button 87. In response, artwork importer 39 generates artwork description data 42F that describes that composition of the packaging graphic, including metadata that describes each element and the assigned packaging field type. Alternatively, the user may abort the process by selecting the CANCEL button 88.

The following pseudo code illustrates exemplary artwork description data 42F generated by artwork importer 39 for the exemplary packaging graphic of FIG. 5:

```
<GRAPHIC NAME=“EXAMPLE_PACKAGING_LAYOUT”
TYPE=“QXD”>
  <ELEMENT ID=1 TYPE=“IMAGE” FIELD_TYPE=“LOGO”
  FILE=“GRAPHIC_1.EPS”/>
  <ELEMENT ID=2 TYPE=“IMAGE” FIELD_TYPE=“LOGO”
  FILE=“GRAPHIC_2.EPS”/>
  <ELEMENT ID=3 TYPE=“TEXT” FIELD_TYPE=“P_NAME”
FILE=“TEXT_SEG_1.EPS”/>
  <ELEMENT ID=4 TYPE=“TEXT” FIELD_TYPE=“P_CODE”
FILE=“TEXT_SEG_2.EPS”/>
  <ELEMENT ID=5 TYPE=“TEXT” FIELD_TYPE=“P_INFO” FILE=“
TEXT_SEG_3.EPS”/>
  <ELEMENT ID=6 TYPE=“TEXT” FIELD_TYPE=“LEVEL”
  FILE=“ TEXT_SEG_3.EPS”/>
  <ELEMENT ID=7 TYPE=“IMAGE” FIELD_TYPE=“BARCODE”
FILE=“GRAPHIC_3.JPG”/>
  <ELEMENT ID=8 TYPE=“TEXT” FIELD_TYPE=“S_INFO”
  FILE=“TEST_SEG_3”/>
</GRAPHIC>
```

In this simplistic example, the exemplary artwork description data 42F conforms to XML, and includes tags that describe each graphical and textual element of the imported graphic. Moreover, each tag lists the element identifier, the type of element, the assigned packaging field, and the particular file that stores the element.

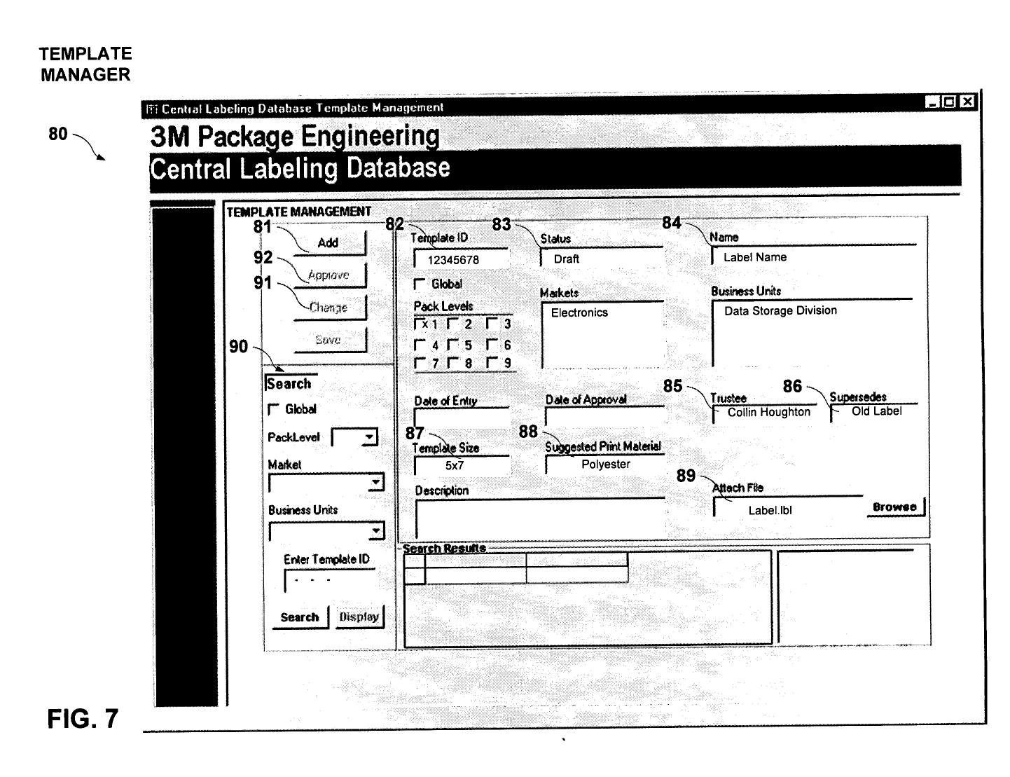

FIG. 7 illustrates an example web-based user interface 80 presented by template manager 24. An authorized user can check-in templates to CPD management system 4 by clicking on the Add button 81, at which time CPD management system 4 automatically assigns a unique template ID 82 and initializes a publication status 83 to “Draft.” At this time, the user can assign a template name 84.

Interface 80 provided by template manager 24 supports the logical categories defined by the corporation for managing templates throughout customers 6. When adding a new template, for example, the user may mark the template as global to make the template available throughout the company. Alternatively, the user may specify a packaging level, business unit and market for the template. The trustee 85 indicates the user that has authority to modify the template being checked-in, typically the user that created the template using graphic design tool 22.

Often, a template may supersede an older template, as identified by window 85. Template size 87, such as 5×7, indicates the physical size of the template when printed. All of the parameters and attributes captured by template manager 24 will be stored in CPD management system 4 and be available later to the user via other software modules 21, including record manager 32 and output manager 34. The user can suggest print material for the label within window 88. When printing the label, as described below, the output manager displays the suggested print material to aid the operator at run-time. Finally, the user can attach a template file produced by the template designer 22 by entering a filename within window 89.

Search window 90 allows the user to locate one of stored packaging template 42B instead of creating a new template. After finding a template, the user can modify the parameters and select change button 91. After finalizing the template, the user can “approve” the template by selecting the approve button 92, thereby marking the template as available for use.

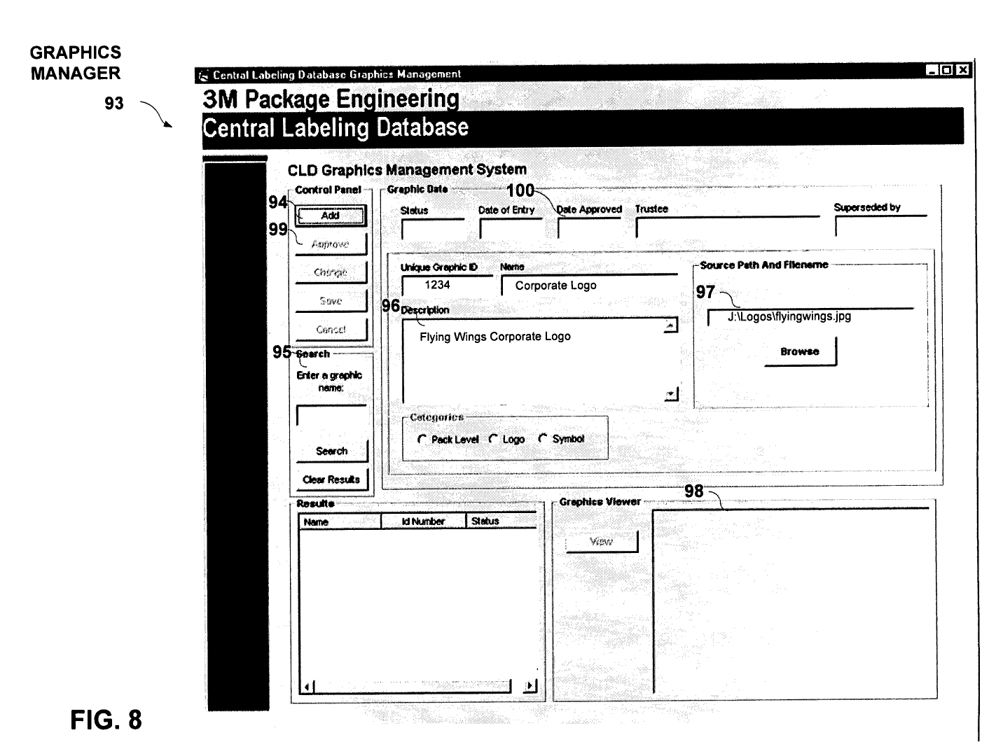

FIG. 8 illustrates an example web-based user interface 93 presented by graphics manager 28 that may be used to trigger artwork importation. Initially, an authorized user can upload graphics for importation to CPD management system 4 by clicking on the Add button 94 after completing the various fields presented by interface 93, at which time CPD management system 4 automatically assigns a unique graphic ID and initializes a status for the packaging graphic to “Draft.” Typically, the user assigns a name to the packaging graphic 95, provides a short description 96 and provides a location 97 where the associated graphic files are located and ready for importation. Interface 93 provides viewer 98 by which the user can preview the packaging layout. Upon approving the graphic layout, by selecting the Approve button 99, graphic manager 28 changes the status to approved and records the date approved 100.

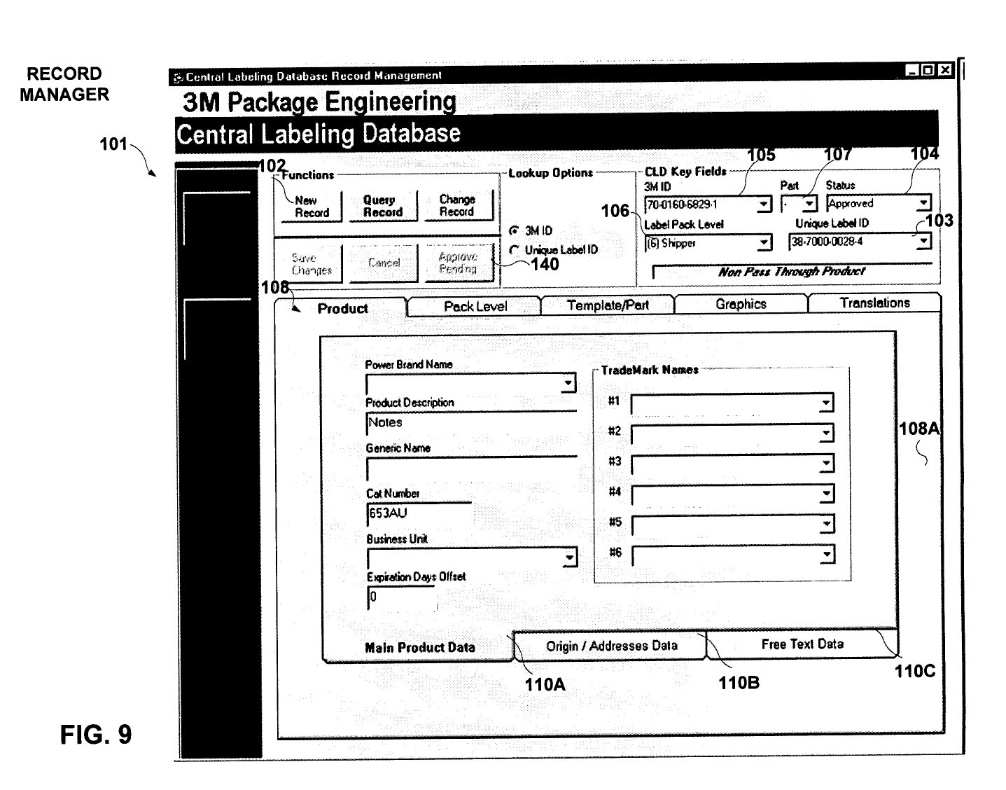

FIGS. 9-14 illustrate an example web-based user interface 101 presented by record manager 32. Generally, interface 101 allows users to define labels for use on packaging and manufactured products using on packaging templates and graphics uploaded to CPD management system 4 by template manager 22 and graphics manager 28, respectively. Referring to FIG. 6, users interact with interface 101 presented by record manager 32 to provide data for the fields of a selected template. The user may, for example, associate a field with text, graphics or other data.

To create a packaging record, a user having rights to access record manager 32 selects New Record button 102 at which time CPD management system 4 automatically assigns a unique label ID 103 and initializes a status 104 for the record to “Draft.” The unique label ID is useful for compliance with regulations, such as the regulations found in the health care and pharmaceutical industries that require a labeling change management process, for example utilizing a single, unique control number for each label.

The user may also select a pre-existing packaging record and make changes. Interface 101 offers two mechanisms for selecting a record. The user may traverse the logical categories defined for CPD management system 4 by providing, for example, a corporate label ID 105, a packaging level 106, and a corresponding manufactured part or product 107. For a given corporate ID number 102, there may be a number of records covering the various packaging levels. These records form a related family that can share common data, such as a message or warning text that must be displayed on labels for all packaging levels. Another method for finding a label is to supply the unique label ID 103.

When creating a packaging record, CPD management system 4 allows the users to control when manufacturing facilities 8 use an updated label. This may be useful in heavily regulated industries where the manufacturing company may need to record the specific point where labels change, such as in the medical and pharmaceutical industries. In particular, the user can classify the record as “pass through” or as “non-pass through.” The output manager 34 uses an updated label immediately if the label is designated as “pass through.” Once a user has approved a pass through packaging record, the old record is immediately replaced and an image of the label for the old record is archived in a graphic format, such as PDF, to create a permanent record of the old label.

For non-pass through labels, output manager 34 allows the manufacturing facilities 8 to control when the updated packaging record is used in place of the superceded packaging record. This allows the manufacturing facilities 8 to print the older labels for a desired period of time, such as until the end of a batch run or the depletion of current inventory. During this process, CPD management system 4 automatically maintains a duplicate packaging record within Packaging records 42C controlled by the corporate ID number. Manufacturing facilities 8 can elect when to replace the old record with the updated one.

Interface 101 provides a number of data entry windows 108 for mapping extracted layout elements, such as textual and graphical elements, to corresponding fields within the selected packaging template. In other words, data entry windows 108 allow the user to select and associate specific elements with each field of the selected template. Record manager 32 determines the defined fields for the selected packaging template, and presents those fields within data entry windows 108. For each field, record manager provides an input area, e.g., a text entry box or a drop-down menu, by which the user selects extracted textual or graphical elements or otherwise provides input to populate the fields of the template record being created. Data entry windows 108 may require that the input from the user match constraints defined within template manager 24 during template creation. In this manner, the template may control the number of characters and format for each field.

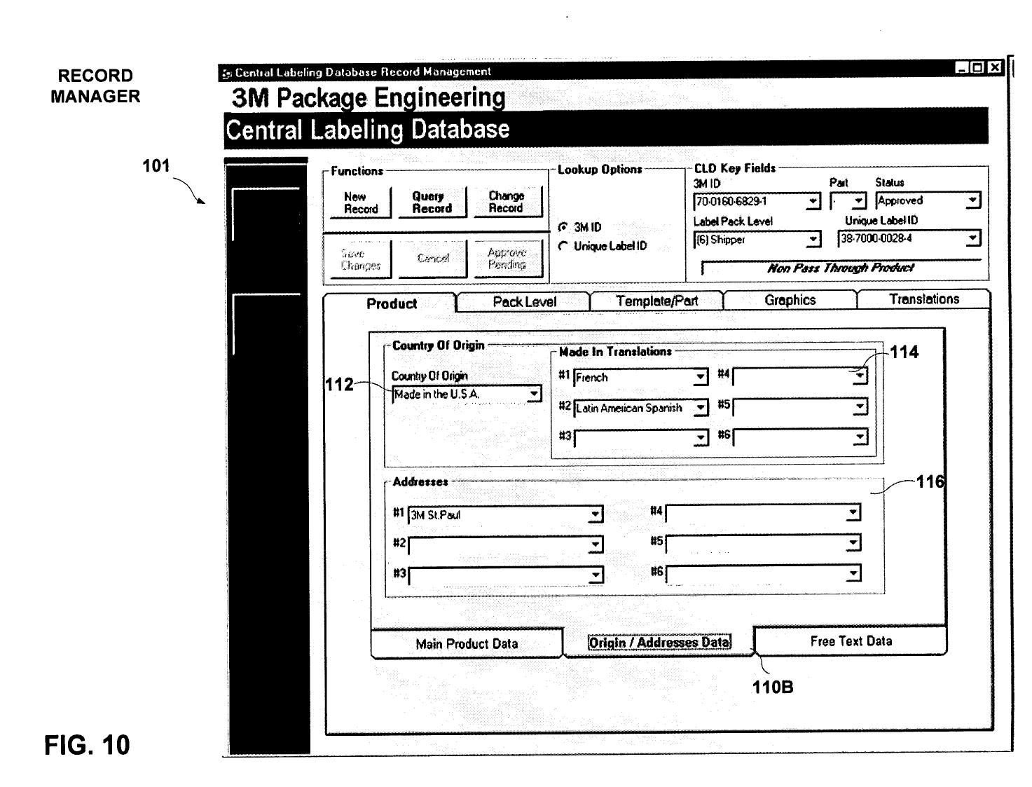

Product data entry window 108A, for example, captures product specific data for the selected packaging record and includes three windows including main product data entry window 110A, origin-address data entry window 110B and free text data entry window 110C. As illustrated in FIG. 10, origin-address data entry window 110B allows a user to specify a country of origin 112 for the product, translations 114 that are available for the label, and an address 116 of the manufacturer. Free text data allows the user to add miscellaneous messages such as “50% off” or “Buy one get one free” to a label. For each of these fields, the user may select a textual segment extracted by artwork importer 39 that is associated with the particular field type. Alternatively, the user may insert textual data.

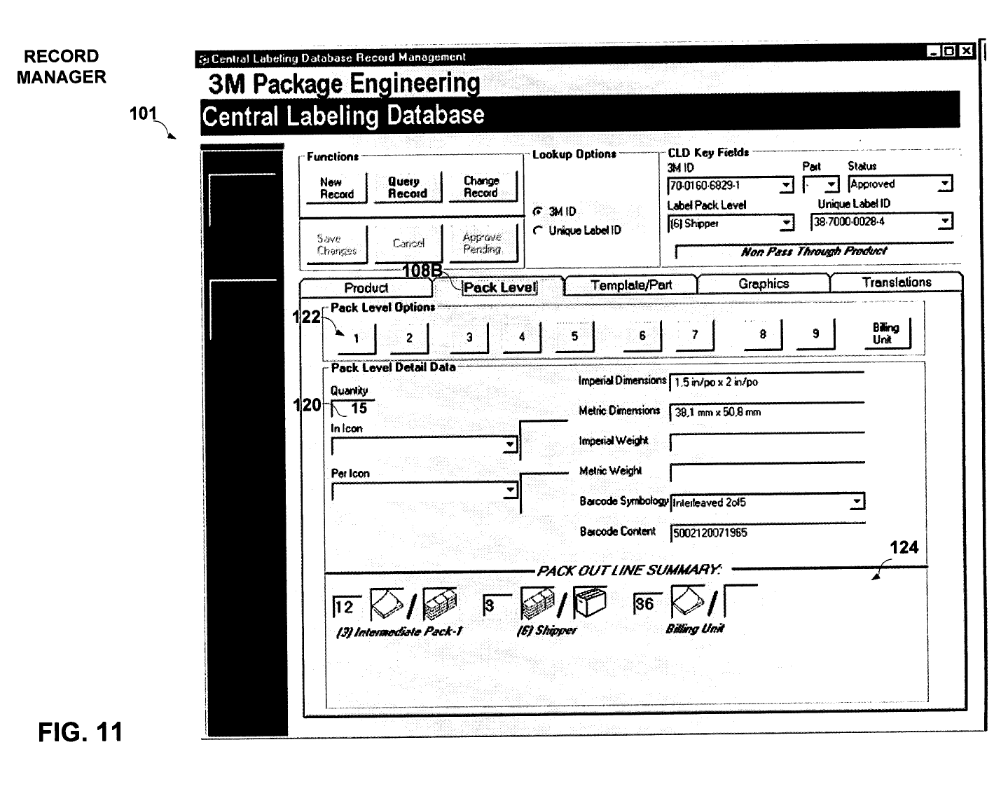

FIG. 11 illustrates packaging level data entry window 108B of user interface 101. Packaging level data entry window 108B allows the user to identify the packaging levels for a manufacturing product. In particular, the user can define the quantity 120 of the product within each of packaging levels 122, and define various features, such as size and weight, at each level. In addition, the user may select graphical icons representing the components and container for each packaging level. Window 124 graphically illustrates the packaging process.

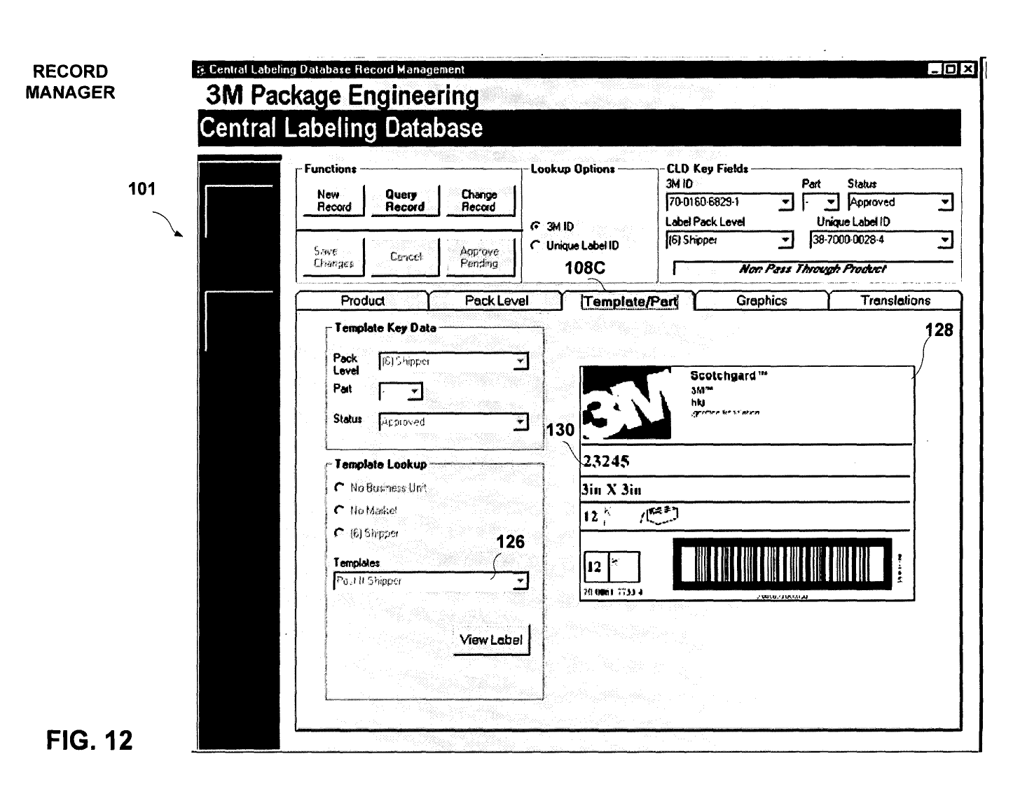

FIG. 12 illustrates template-part data entry window 108C of user interface 101. Template-part data entry window 108C allows the user to identify the corresponding template 126 for the current packaging record, and displays an image 128 that graphically illustrates the label as well as the corresponding fields 130 associated with the label.

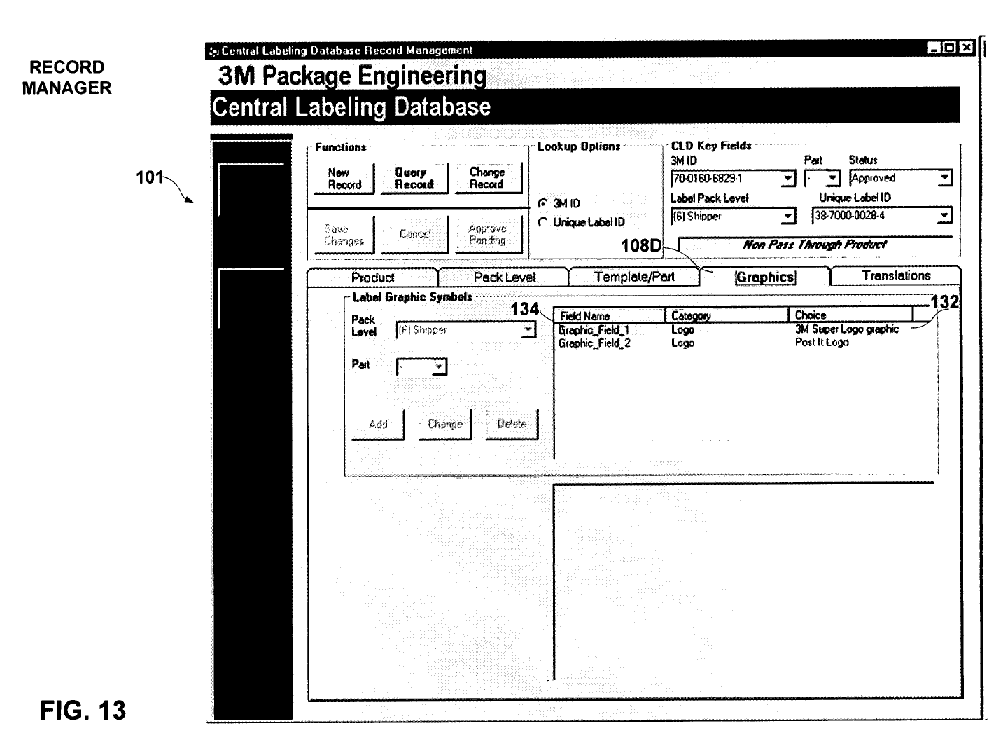

FIG. 13 illustrates graphics data entry window 108D of user interface 101 that allows the user to assign graphic elements 132 from artwork data 42A to the various fields 134 within the template. In particular, for each of fields 134, user interface 101 presents a drop-down menu that lists those graphical elements that have been imported and specifically associated with the field type via reconciliation interface 80.

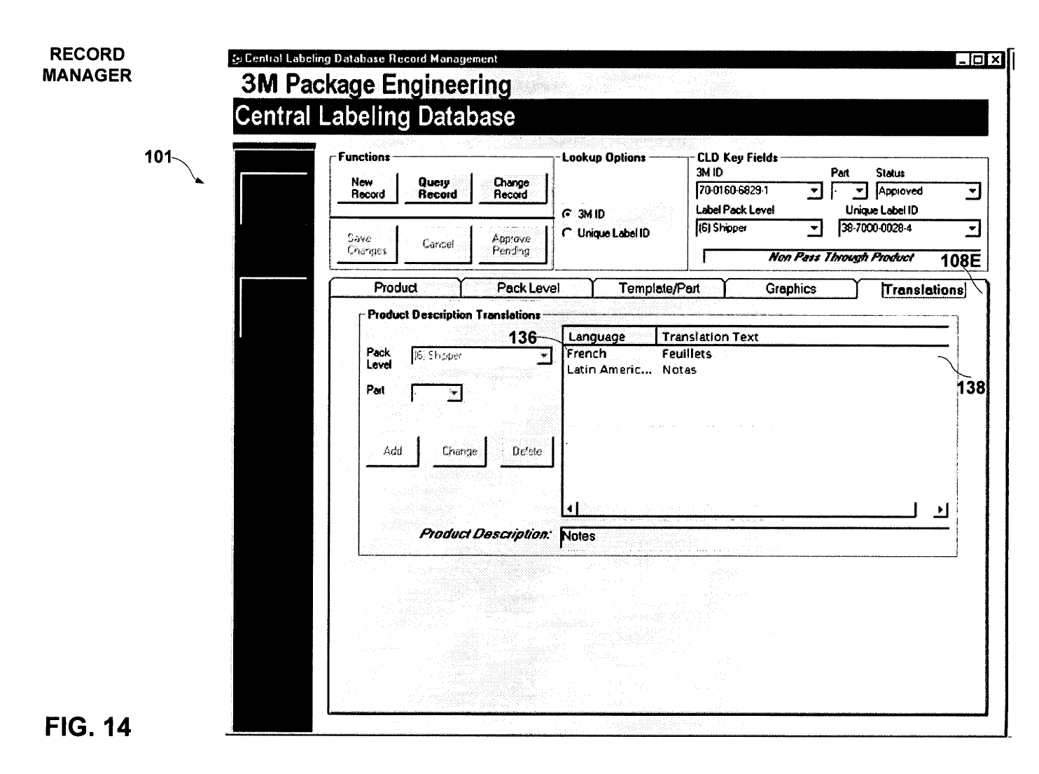

FIG. 14 illustrates translations data entry window 108 E of user interface 101 that allows the user to select one or more languages 136 for the label and enter translation text 138 for one or more fields. In this manner, any text on the label can be multilingual. In one embodiment, CPD management system 4 is Unicode compliant and can readily support a wide variety of character sets.

Referring again to FIG. 9, once the user has completed the field population process, the user can approve the label by selecting Approve button 140. Upon approval, record manager 32 generates an image, such as a PDF file, of the resultant label based on the graphics and other data associated with the fields of the selected label. In addition, record manager 32 timestamps the image and archives the image to record a visual representation of the exact label that is available for use by manufacturing facilities 8. CPD management system 4 associates data from the current record with the archived image to allow for indexing and quick retrieval.

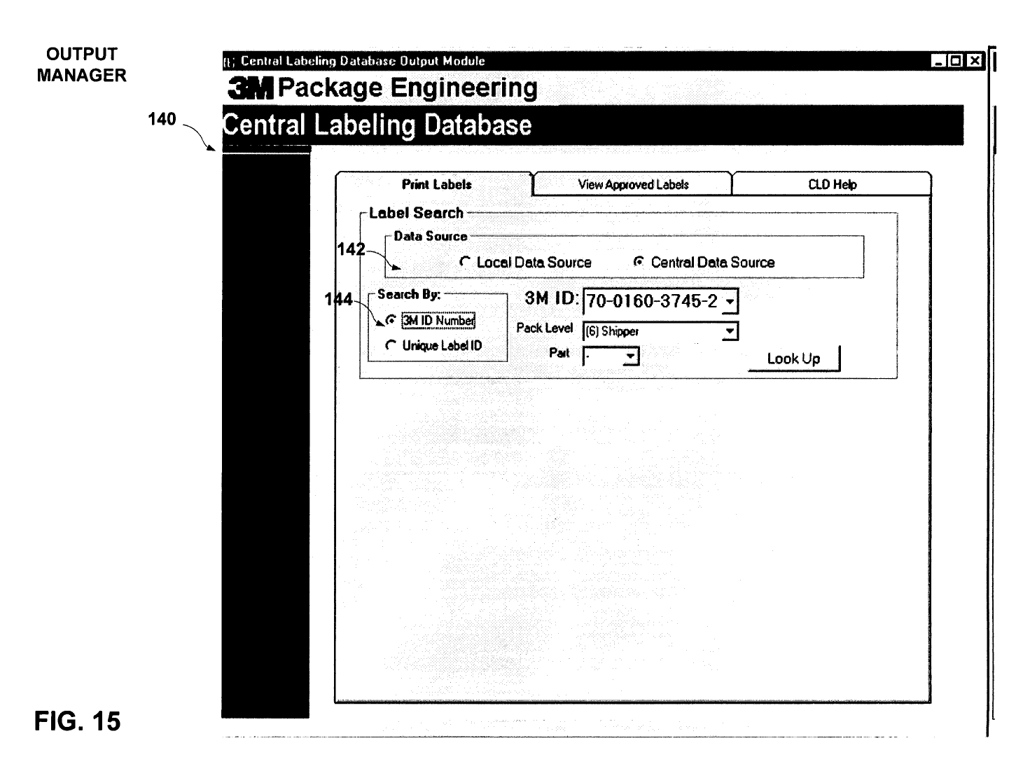

FIGS. 15-17 illustrate an example web-based user interface 140 presented by output manager 34. Generally, interface 140 controls all aspects of label printing by manufacturing facilities 8. Referring to FIG. 15, a user, such as a plant operator within one of manufacturing facilities 8, first interacts with data source selection window 142 to elect whether to retrieve packaging data from CPD management system 4 via network 9, or from a local copy of data stores 42. This option is useful to maintain manufacturing ability even in situations where network 9 is unavailable. Specifically, CPD management system 4 may replicate data stores 42, or portions thereof, to local servers within each manufacturing facility 8 and print center 16.

After selecting the data source, the user then selects a desired packaging record using search window 144. In particular, the user can enter a unique label ID, or a corporate ID and corresponding packaging level and part. Only Packaging records having an approved status are available to the user via output manager 34. This gives business unit 4 the ability to manage packaging data, create new labels, and update labels without worrying about the manufacturing facilities 8 prematurely using non-approved labels.

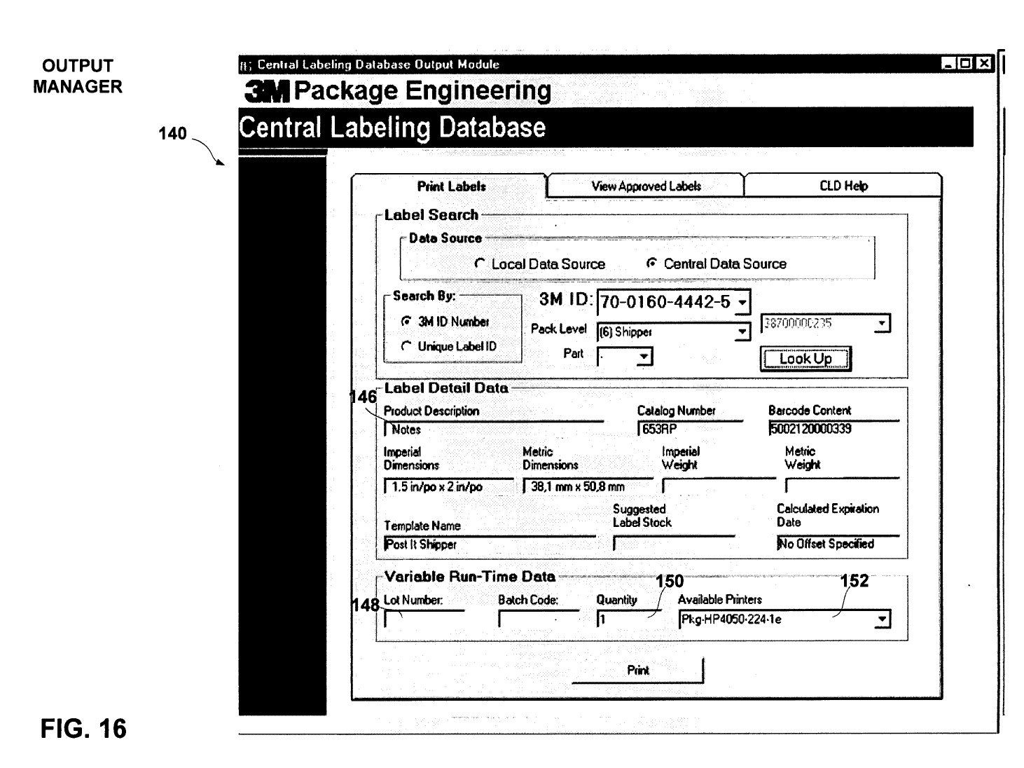

As illustrated in FIG. 16, once a label is identified, output manager 34 retrieves the detailed data for the label from Packaging records 42C and displays the data within window 146. Interface 140 displays this information in non-editable form for verification by the user. In addition, interface 140 displays any run-time fields 148, such as fields 150 and 152, for capturing data as, for example, lot number and batch code. Next, the plant operator selects a quantity 150 and an available printer 152. As described above, output manager 34 controls the list of available printers 152 based on access settings within config data 42D.

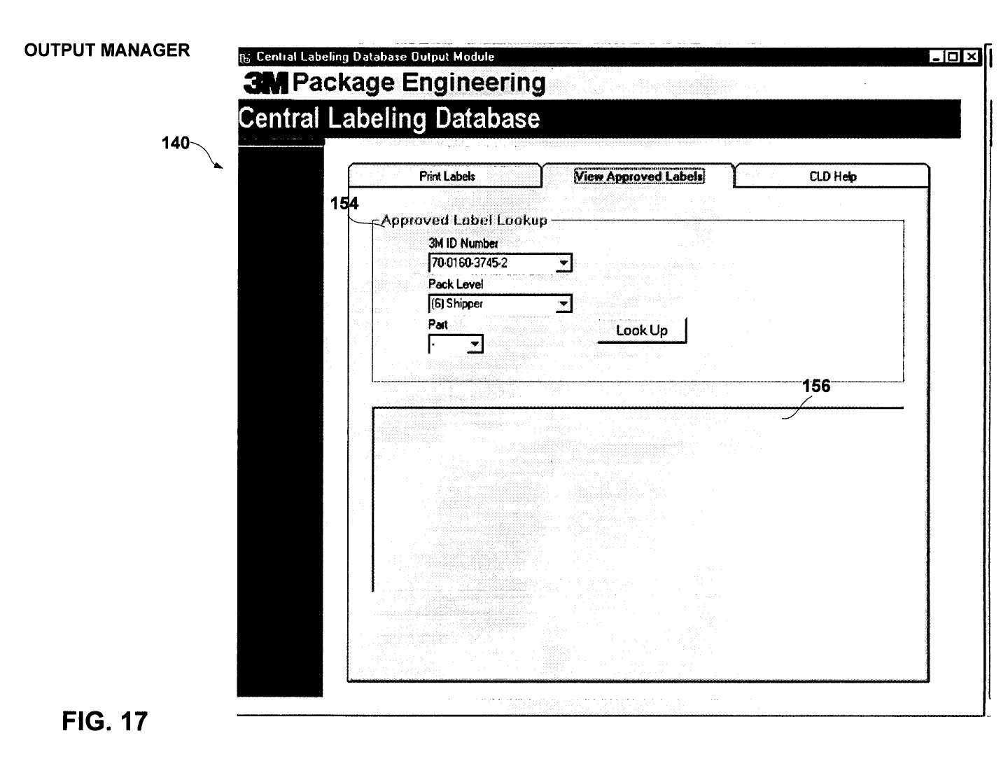

As illustrated in FIG. 17, viewing approved labels window 154 of output manager 34 provides the ability to verify a printed label or other packaging material in comparison with the approved packaging record as archived by record manager 32. More specifically, the user may typically print a single label and compare the printed label against the archived image displayed in view screen 156. Verification against the archived label is more accurate than performing a print preview, as commonly available in conventional systems. A print preview only displays the packaging record that is about to be printed, versus displaying the exact approved version. This feature may be particularly useful for regulated industries. Upon verifying the packaging record, the user selects a print mode and quantity, and prints either individually, continuously, or a combination thereof. Alternatively, the user may store the generated labels to a computer-readable file in a variety of formats, such as EPS or bitmap. The user may then ship the generated label to a high-end print service for printing large volume batches.

Various implementations and embodiments of the invention have been described. For instance, a management system for developing and managing packaging labels or other printed material for manufactured products has been described. The components of the system may be implemented as server-side components, client-side components, or a combination thereof. Nevertheless, it is understood that various modifications can be made without departing from the invention. Accordingly, these and other embodiments are within the scope of the following claims.

1. A method comprising:
processing a graphic file to identify elements of a packaging layout;
generating information that associates the elements with types of data fields of a packaging template;
presenting an interface for populating the data fields of the packaging template with the elements in accordance with the information to form a packaging record; and
communicating the packaging record to an output location for printing packaging material.

2. The method of claim 1, wherein processing the graphic file comprises parsing the graphic file to identify graphical elements and textual elements.

3. The method of claim 1, further comprising:
storing the elements within a packaging data management system;
selecting one or more of the elements based input received from the user; and
generating the packaging record to identify the selected elements.

4. The method of claim 1, wherein generating information comprises:
presenting a reconciliation interface to receive input that maps each of the elements to a respective one of the types of data fields of the packaging template; and
generating the information based on the input, wherein the information describes the mapping between the elements and the types of data fields of the packaging template.

5. The method of claim 4, wherein presenting a reconciliation interface comprises presenting the reconciliation interface to include a display area that illustrates the packaging layout.

6. The method of claim 5, further comprising generating the display area to include graphical indicators for each of the identified elements of the packaging layout.

7. The method of claim 5, further comprising:
assigning each of the elements with a unique identifier; and
generating the display area to graphically label each of the elements with the corresponding identifier.

8. The method of claim 4, wherein presenting a reconciliation interface comprises presenting the reconciliation interface to include an element description area that lists the elements identified within the graphic file.

9. The method of claim 4, wherein presenting a reconciliation interface comprises presenting the reconciliation interface to include a data type assignment area having a set of inputs for assigning the graphical elements to respective types of the data fields of the packaging template.

10. The method of claim 9, further comprising generating the inputs of the data type assignment area to include drop-down menus that list the types of data fields of the packaging template.

11. The method of claim 1, further comprising:
storing the elements within a packaging data management system;
storing the information within a searchable database of the packaging data management system;
accessing the searchable database based input received via the interface to locate and select one or more of the elements for the packaging record; and
generating the packaging record to include the selected elements.

12. The method of claim 1, further comprising printing the packaging material at the output location in accordance with the packaging record.

13. The method of claim 12, wherein printing the packaging material comprises printing a label.

14. The method of claim 1, wherein communicating the packaging record comprises communicating the packaging record to a manufacturing facility via a network.

15. The method of claim 1, wherein generating information comprises generating the information as metadata in accordance with a data description language.

16. The method of claim 15, wherein generating the information as metadata comprises generating the information as metadata in accordance with the extensible Markup Language (XML).

17. A packaging data management system comprising:
a set of packaging templates having data fields selected from a set of data field types;
an artwork importation module that processes a graphic file to identify elements of a packaging layout, wherein the artwork importer generates information that associates each of the elements with a respective one of the data field types of the packaging templates;
a record manager that presents an interface by which a user selects one of the packaging templates and populates the data fields of the selected packaging template with the elements based on the information to form a packaging record; and
an output manager that communicates the packaging record to an output location to control printing of a packaging material.

18. The packaging data management system of claim 17, wherein the artwork importer parses the graphic file to identify graphical elements and textual elements.

19. The system of claim 17, wherein the artwork importation module presents a reconciliation interface to receive input that maps each of the elements to a respective one of the data field types, and generates the information based on the input to describe the mapping.

20. The packaging data management system of claim 19, wherein the reconciliation interface includes a display area that illustrates the packaging layout.

21. The packaging data management system of claim 20, wherein the display area includes graphical indicators for each of the identified elements of the packaging layout.

22. The packaging data management system of claim 20, wherein the artwork importation module assigns a unique identifier to each of the elements, and generates the display area to graphically label each of the elements with the corresponding identifier.

23. The packaging data management system of claim 19, wherein the reconciliation interface includes an element description area that lists the elements identified within the graphic file.

24. The packaging data management system of claim 19, wherein the reconciliation interface includes a data type assignment area having a set of inputs for assigning the graphical elements to respective types of the data fields of the packaging template.

25. The packaging data management system of claim 24, wherein the inputs of the data type assignment area comprise drop-down menus that list the types of data fields of the packaging template for selection by the user.

26. The packaging data management system of claim 17, further comprising:
a server to store the elements; and
a database to store the information,
wherein the record manager accesses the database based input received via the interface to locate and select one or more of the elements for the packaging record.

27. The packaging data management system of claim 17, wherein the output location comprises a manufacturing facility.

28. The packaging data management system of claim 17, wherein the artwork importation module generates the information as metadata in accordance with a data description language.

29. The packaging data management system of claim 28, wherein the artwork importation module generates the metadata in accordance with the eXtensible Markup Language (XML).

30. The packaging data management system of claim 17, further comprising a rules engine to validate the packaging records in accordance with a set of rules.

31. An online packaging data management system comprising:
means for centrally storing packaging templates that define a set of data field types;
means for processing a packaging layout to identify elements;
means for mapping the elements to the data field types of the packaging templates; and
means for generating a packaging record from the elements, the packing templates, and the mapping.

32. The online packaging data management system of claim 31, further comprising means for printing packaging material in accordance with the packaging record.

33. A computer-readable medium comprising instructions to cause a processor to:
process a graphic file to identify elements of a packaging layout;
generate information that associates the elements with types of data fields of a packaging template;
present an interface for populating the data fields of the packaging template with the elements in accordance with the information to form a packaging record; and
communicate the packaging record to an output location for printing packaging material.

34. The computer-readable medium of claim 33, further comprising instructions to cause the processor to:
present a reconciliation interface to receive input that maps each of the elements to a respective one of the types of data fields of the packaging template; and
generate the information based on the input, wherein the information describes the mapping between the elements and the types of data fields of the packaging template

35. The computer-readable medium of claim 34, further comprising instructions to cause the processor to present the reconciliation interface to include a data type assignment area having a set of inputs for assigning the graphical elements to respective types of the data fields of the packaging template.

36. The computer-readable medium of claim 31, further comprising instructions to cause the processor to generate the information as metadata in conformance with a data description language.
